(19) United States
(12) Patent Application Publication
(10) Pub. No.: US 2013/0269102 A1
(43) Pub. Date: Oct. 17, 2013

(54) Patient Turner

(71) Applicant: John Albert Raven, Kentland, IN (US)

(72) Inventor: John Albert Raven, Kentland, IN (US)

(21) Appl. No.: 13/446,668

(22) Filed: Apr. 13, 2012

(51) Int. Cl. A61G 5/14

(52) U.S. Cl. 5/81.1 RP

(57) ABSTRACT

An improvement to devices known as “patient turners”, provides for a hand controlled brake and locking mechanism that positively locks the rotatable platform of these devices to their stationary base. The activation or deactivation of the mechanism is done by hand at a grab handle of the device instead of by foot at the base of the device. This allows the assistant using the device to rotate a patient standing on the platform to always keep two hands on the device and both feet on the floor during the whole rotation process. This process includes the activation of the braking and locking mechanism to prevent accidental and unplanned rotation of the platform, the patient getting onto the platform, the deactivation of the mechanism, the rotation of the patient on the platform by the assistant, the activation of the mechanism, and the patient getting off the platform.

### GENERAL FIELD OF INVENTION

This invention relates directly to existing and planned patient turners that are used and will be used in the care of partially disabled patients found in homes, nursing homes, hospitals, rehabilitation centers, etc.

### BACKGROUND OF THE INVENTION

Current patient turners have existed for decades providing the partially disabled a means, with assistance, of more easily getting out of bed into a standing position to then be rotated to an angle that would line the patient up with a wheel chair, for example. The use of these devices can and do reduce the number of personnel needed to accomplish these tasks down to one caregiver or assistant. The use of these devices with one assistant does not come without risk—the patient can topple over if the device is not firmly held in place by the assistant. Also, if the rotatable platform is allowed to turn while the patient is pulling himself up out of bed into a standing position on the platform, the patient could rotate unexpectedly resulting in a costly fall.

Most patient turners have provided a foot brake (see noted references in information disclosure statement) that is used to prevent the rotatable platform from turning so as to help prevent the above latter from happening. But, with most of these applications, the caregiver or assistant must keep pressure on the foot brake in order to keep the platform from turning. This results in the assistant having one foot off the floor, causing an unstable condition that can lead to a possible fall off the platform if the assistant cannot keep the patient turner stable with two hands and one foot on the floor. Also, insufficient foot pressure may still allow the platform to rotate unexpectedly.

One manufacturer has attempted to reduce the possibility of this happening by the introduction of a foot brake that stays in either the applied position or the unapplied position without the use of constant foot pressure (see noted references in disclosure). Although a good improvement over the foot brake described in the previous paragraph, it still leaves the possibility that while the assistant applies or unapplies the foot brake, the patient tries to get onto or off the platform at the wrong time and turns unexpectedly causing a fall or leans heavily in one direction catching the assistant in an unstable condition resulting in a topple. Also, the foot brake described above, if a friction brake, may still allow the platform to rotate unexpectedly if the friction surfaces are altered, such as from a liquid spill or from the deterioration of one or both friction surfaces that cause one or both to lose friction.

This invention is an attempt to reduce the possibility of the aforementioned from happening.

### SUMMARY OF INVENTION

The primary object of this invention is to preclude the need of the operator of a patient turner to lift a foot or remove a hand from the patient turner in order to engage or disengage a device used to prevent the rotation of the patient platform of the patient turner. Secondary objects of this invention are to provide a device controlled by hand that interlocks the rotatable platform of a patient turner with its stationary base by mechanical means and not be friction; also to incorporate into that device an automated feature that ensures the insertion of the mechanical means to interlock the rotatable platform with its stationary base when the operator wants it and while slow and controlled rotation is occurring.

These important objects are achieved by the use of a braking and interlocking device used between the rotating platform and its stationary base controlled by a device mounted on the grab handle used by the operator of the patient turner. The mounted controlling device on the grab handle is one that can be operated by the hand or finger(s) of the operator while still holding the grab handle. The braking and interlocking device incorporates the means to apply constant pressure on the interlocking component so as to ensure the application of the interlocking component when predetermined matching locations on the rotatable platform and stationary base align during the relative rotational movement that occurs between them.

### BRIEF DESCRIPTION OF EACH FIGURE IN DRAWING

FIG. 1 is an angle view of a patient turner with the improvement included. The improvement is shown in a normally unlocked and unapplied configuration.

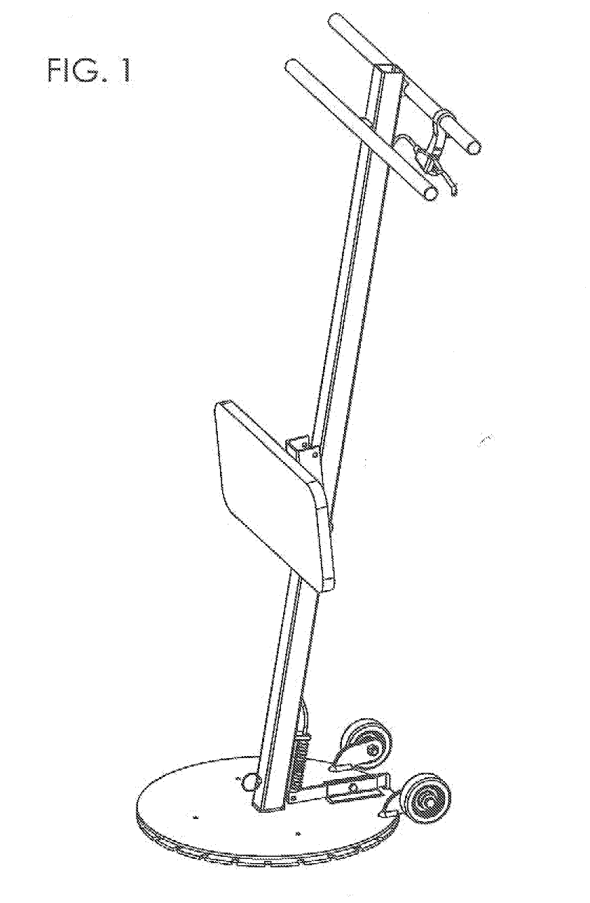

FIG. 2 is an angle view of the major components of the improvement shown alone from the patient turner shown in FIG. 1.

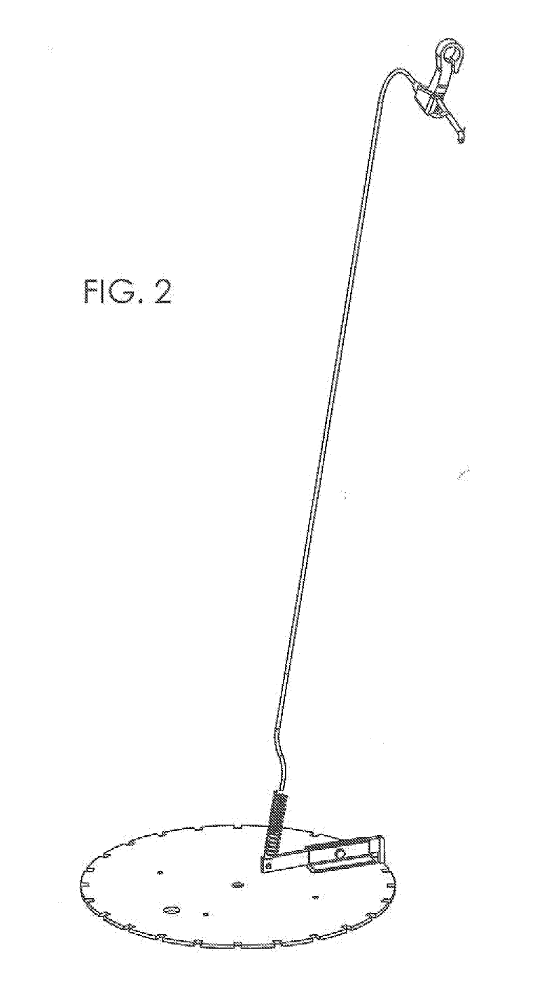

FIG. 3 is an angle view of a patient turner with the improvement included. The improvement is shown in a normally locked and applied configuration.

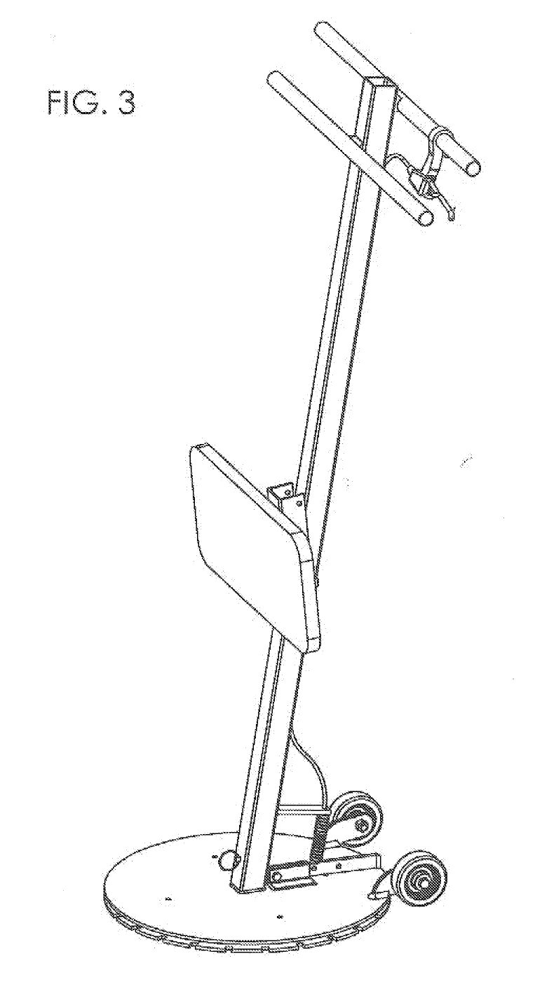

FIG. 4 is an angle view of the major components of the improvement shown alone from the patient turner shown in FIG. 3.

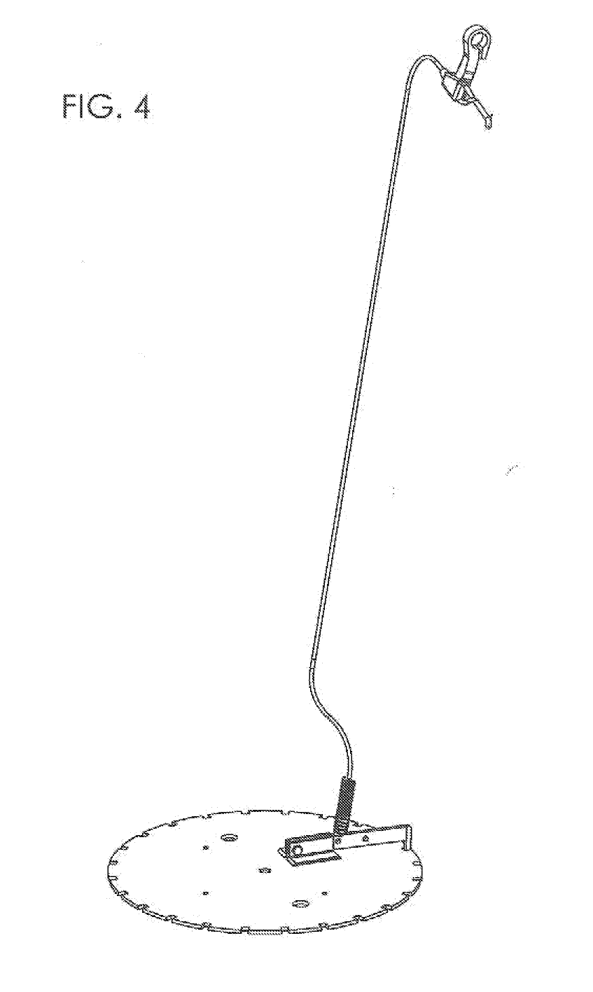

FIG. 5 is a side view of the major components of the improvement in which the brake and locking mechanism is shown in the unapplied and unlocked default configuration.

FIG. 6 is a side view of the major components of the improvement in which the brake and locking mechanism is shown in the applied and locked default configuration.

### DESCRIPTION OF THE PREFERRED EMBODIMENT OF THE INVENTION

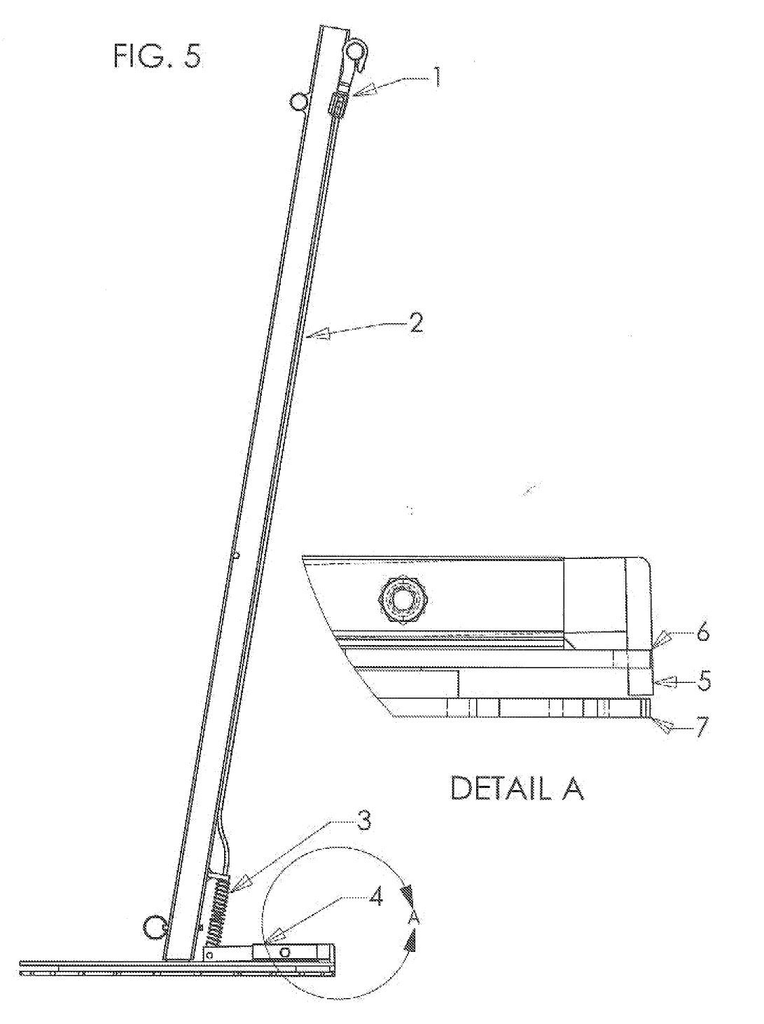

Referring to FIG. 5, the major components of the improvement are shown included in a patient turner. The improvement in this figure is shown in the normally unlocked and unapplied position, which means that as the patient turner stands, the rotatable platform 6 is free to rotate about the stationary base 7 which rests on the floor. The pawl 5 of the brake and locking mechanism is shown disengaged with a slot in the stationary base 7. For this application of the improvement, the remote controlling device 1 is mounted to the top tubular grab handle of the patient turner. This is the grab handle that the patient caregiver or assistant holds onto with one hand on each side of the upright support that the grab handle is attached to. After wheeling the patient turner to the patient's location, the assistant firmly holds onto the grab handle with both hands. At the same time, for this application, the assistant squeezes the hand lever of the remote controlling device 1 while maintaining his grip on the tubular grab handle. The cable 2, for this application, is attached to the pawl lever 4 and pulls the end of the pawl lever 4 upward against the spring 3. Pawl 5 moves downward onto the top of the stationary base 7 if pawl 5 is not aligned with a slot in the stationary base 7. This provides a braking action that impedes the rotational movement of the rotatable platform 6. If the pawl 5 of the pawl lever 4 aligns with a slot in the stationary base 7, pawl 5 will move into this slot being fully engaged with it. This will lock the rotatable platform 6 with the stationary base 7 preventing relative rotation between the two. This locking action will continue as long as the assistant continues to squeeze the hand lever of the remote controlling device 1. The patient, at this time, grabs the lower tubular grab handle, places his feet on the rotatable platform, and lifts himself up to a standing position on the patient turner while holding onto the grab handle. If the pawl 5 of the pawl lever 4 does not align initially with a slot in the stationary base 7, the assistant, in checking that the rotatable platform 6 is locked and cannot rotate, will rotate the rotatable platform slightly until the pawl 5 will align with a slot in the stationary base 7. At that time, pawl 5 will engage fully with this slot due to the continuing downward pressure put upon it as a result of the assistant continuing to squeeze the hand lever of the remote controlling device 1. Also, if the assistant forgets to check that the rotatable platform 6 is locked and cannot rotate, any slight rotational movement occurring while the patient lifts himself up onto the patient turner will cause the pawl 5 to become aligned with one of the multiple slots of the stationary base 7 that have been placed in close proximity with each other around the perimeter of the stationary base 7. As soon as a slot in the stationary base becomes aligned with the pawl 5, pawl 5 will engage fully with this slot due to the continuing downward pressure put upon it as a result of the assistant continuing to squeeze the hand lever of the remote controlling device 1. As soon as the assistant releases the hand lever, spring 3 causes the pawl lever 4 to rotate in FIG. 5 counterclockwise about its pivot thereby causing the pawl 5 to move upward becoming disengaged with the slot in the stationary base 7. The patient can now be rotated to a desired position, such as with a wheelchair. At this point, the assistant again, squeezes the hand lever of the remote controlling device 1, and the process described above with the pawl 5 occurs resulting in the rotatable platform 6 becoming locked with the stationary base 7. The patient can now safely lower himself to the wheelchair.

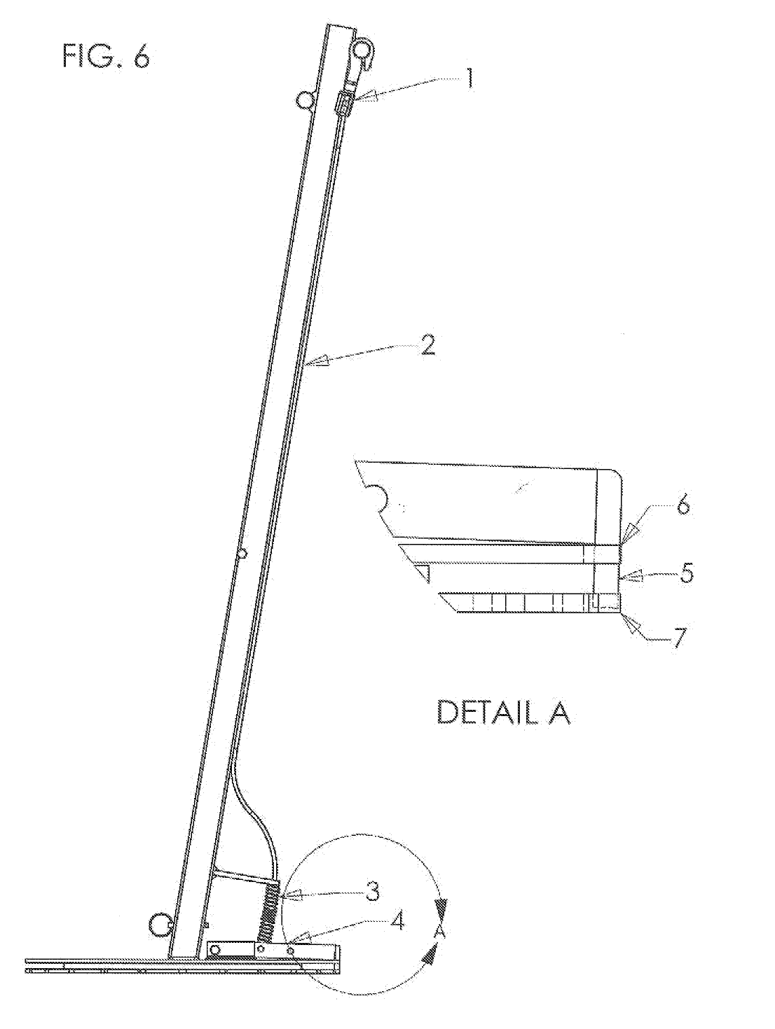

Referring to FIG. 6, the major components of the improvement are shown included in a patient turner. The improvement in this figure is shown in the normally locked and applied position, which means that as the patient turner stands, the rotatable platform 6 is not free to rotate about the stationary base 7 which rests on the floor. The pawl 5 of the locking mechanism is shown engaged with a slot in the stationary base 7. For this application of the improvement, the remote controlling device 1 is mounted to the top tubular grab handle of the patient turner. This is the grab handle that the patient caregiver or assistant holds onto with one hand on each side of the upright support that the grab handle is attached to. After wheeling the patient turner to the patient's location, the assistant firmly holds onto the grab handle with both hands—without squeezing the hand lever of the remote controlling device 1. The cable 2, for this application, is attached to the pawl lever 4 and pulls the pawl lever 4 upward against the spring 3. Spring 3 exerts continuing downward pressure on pawl lever 4 at all times. If the pawl 5 of the pawl lever 4 is not aligned with a slot in the stationary base 7, pawl 5 will contact the top surface of stationary base 7 applying a braking force impeding the relative movement between the stationary base 7 and the rotatable platform 7. If the pawl 5 of the pawl lever 4 aligns with a slot in the stationary base 7, pawl 5 will move into this slot being fully engaged with it. This will lock the rotatable platform 6 with the stationary base 7 preventing relative rotation between the two. This locking action will continue until the assistant squeezes the hand lever of the remote controlling device 1. If the pawl 5 of the pawl lever 4 does not align initially with a slot in the stationary base 7, the assistant, in checking that the rotatable platform 6 is locked and cannot rotate can rotate the rotatable platform 6 while squeezing the hand lever slightly until the pawl 5 is aligned with a slot in the stationary base 7. At that time, pawl 5 will engage fully with this slot due to the continuing downward pressure put upon it as a result of the spring pressure from spring 3. The patient, at this time, grabs the lower tubular grab handle, places his feet on the rotatable platform, and lifts himself up to a standing position on the patient turner while holding onto the grab handle. Also, if the assistant forgets to check that the rotatable platform 6 is locked and cannot rotate, any slight rotational movement occurring while the patient lifts himself up onto the patient turner will cause the pawl 5 to become aligned with one of the multiple slots of the stationary base 7 that have been placed in close proximity with each other around the perimeter of the stationary base 7. As soon as a slot in the stationary base 7 becomes aligned with the pawl 5, pawl 5 will engage fully with this slot due to the continuing downward pressure put upon it as a result of the spring pressure from spring 3. As soon as the assistant squeezes the hand lever, cable 2 causes the pawl lever 4 to rotate in FIG. 6 counterclockwise about its pivot thereby causing the pawl 5 to move upward becoming disengaged with the slot in the stationary base 7. The patient can now be rotated to a desired position, such as with a wheelchair. At this point, the assistant again, releases the hand lever of the remote controlling device 1, and the process described above with the pawl 5 occurs resulting in the rotatable platform 6 becoming locked with the stationary base 7. The patient can now safely lower himself to the wheelchair.

1. A remotely controlled non-geared, non-chained, or non-belted friction braking mechanism used to impede the relative motion between the rotatable platform and stationary base of portable patient transfer devices better known as “patient turners” or “patient transfer stands” that enable partially immobile patients who cannot walk or walk without assistance, but can place or have their feet placed on the rotatable platform of such devices and can use their hands to assist in pulling themselves up to a standing position by grabbing the handle(s) of such devices allowing the assistant or operator of such devices to rotate such standing patients to align with a chair, bed, toilet seat, etc., allowing such patients to sit on such structures; said mechanism constitutes and improvement to such devices wherein the improvement comprises:
a controlling device mounted separately to the patient turner or transfer stand from the said non-geared, non-chained, or non-belted friction braking mechanism that allows for the operator of the patient turner or transfer stand to engage or disengage a non-geared, non-chained, or non-belted friction braking component of said mechanism by hand or finger(s) while maintaining gripping pressure on handle(s) of said patient turner or transfer stand by both hands—not requiring the removal of a hand or hands from the said handle(s) of said patient turner or transfer stand in order to operate said controlling device; and the said non-geared, non-chained, or non-belted friction braking component, which provides the means for impeding the relative motion between the said rotatable platform and stationary base of said patient turners or transfer stands.

2. A remotely controlled non-geared, non-chained, or non-belted interlocking mechanism used to interlock the rotatable platform and stationary base of portable patient transfer devices better known as “patient turners” or “patient transfer stands” that enable partially immobile patients who cannot walk or walk without assistance, but can place or have their feet placed on the rotatable platform of such devices and can use their hands to assist in pulling themselves up to a standing position by grabbing the handle(s) of such devices allowing the assistant or operator of such devices to rotate such standing patients to align with a chair, bed, toilet seat, etc., allowing such patients to sit on such structures; said mechanism constitutes an improvement to such devices wherein the improvement comprises:
a controlling device mounted separately to the patient turner or transfer stand from said non-geared, non-chained, or non-belted interlocking mechanism that allows for the operator of the patient turner or transfer stand to engage or disengage an interlocking component of said mechanism by hand or finger(s) while maintaining gripping pressure on handle(s) of said patient turner or stand by both hands—not requiring the removal of a hand or hands from the said handle(s) of said patient turner or transfer stand in order to operate said controlling device; and the said non-geared, non-chained, or non-belted interlocking mechanism of said patient turner or transfer stand, which provides the means for locking together the said rotatable platform and stationary base of said patient turners; said non-geared, non-chained, or non-belted interlocking mechanism incorporates a means to apply constant pressure on said interlocking component of said mechanism so as to ensure the application of said interlocking component when predetermined matching locations on the said rotatable platform and stationary base align during the relative rotational movement that occurs between them.
